(19) United States
(12) Patent Application Publication
(10) Pub. No.: US 2013/0333047 A1
(43) Pub. Date: Dec. 12, 2013

(54) ELECTRONIC COMMUNICATION SECURITY SYSTEMS

(71) Applicant: Hal William Gibson, Long Beach, CA (US)

(72) Inventor: Hal William Gibson, Long Beach, CA (US)

(21) Appl. No.: 13/490,658

(22) Filed: Jun. 7, 2012

(51) Int. Cl. G06F 21/24; G06F 15/16

(52) U.S. Cl. 726/26

(57) ABSTRACT

Embodiments of the invention relate to methods increasing the security of electronic messages.

### FIELD

Embodiments of the present invention provide systems, methods, and devices for improving the security of electronic communications.

### BACKGROUND

Electronic communications have assumed tremendous importance in business as well as social venues. With this importance has arisen an increased risk of sending electronic communications prematurely, for example before the message has been proofread or before the addressees have been assigned and verified. Current methods of initiating the “send” process often require only a single user action to “trigger” the process and thus are susceptible to accidental initiation. Further, current methods of addressing electronic communications fail to adequately safeguard informational security. For example, the “auto-fill” feature of many email software programs contributes to this problem. Therefore, improved methods for increasing the security of electronic communications are necessary.

### SUMMARY

In an embodiment, a method of the invention includes the following steps:

Inputting a destination address;

Associating a designator with the destination addresses;

Producing the associated designator;

Reviewing the associated designator;

If the review criteria are not satisfied, transmission of the message can be prevented. If the review criteria are satisfied, transmission of the message can be initiated.

In an embodiment, a system of the invention includes the following;

Means for accepting input from a user;

Means for assigning a designator to the input data;

Means for reviewing the designator;

An embodiment of the invention can comprise associating at least one visually recognizable designator to the destination address, wherein the designator is associated based upon the domain name of the destination address; producing for visual review the designator in conjunction with the destination address; visually reviewing the designator assigned to the destination address; and preventing transmission of the email if the designator of the email's destination address is not valid.

Definitions

“add to, modify, or replace” in the context of the invention means software or hardware that can augment existing electronic communications systems to alter the systems' capability, such as by increasing the overall security of the system. Software embodiments of the system can be added to existing electronic message systems to add the capabilities of the invention to the existing electronic message system.

“addressee” means the intended recipient of an electronic message, such the email addressee, domain name, or phone number.

“addressor” means the creator of an electronic message, such as the email creator, text message creator, etc.

“assigning” in the context of the invention means associating a designator with an addressee, such as associating a color with an email addressee, or assigning a sound to a domain name, or associating a vibration to a phone number.

“associating” or “associate” in the context of the invention means assigning a designator to an electrnic message destination address, such as assigning a color to an email addressee, or assigning a sound to a domain name. The assigning is performed based on criteria established by the user or a third party. Associating can be performed by the user or automatically by the invention as the user/message creator enters an destination address. For example, once a user enters a destination address a system of the invention can assign a designator to that destination address based on criteria including, for example, the domain name, the phone number, etc., of the destination address.

“attached file” or “attachment” means any file that is transmitted along with an electronic message such as, for example, a photograph attached to a text message, or a document attached to an email.

“audible” means of a volume sufficient to be recognized by the reviewer.

“criteria” means the metric, standards, or rules used in analyzing designators. For example, if the criteria includes a requirement that all addressees of a communication are assigned the same color designator, then the reviewer can prevent the transmission of a message whose addressees include designators of multiple colors. Criteria can be applied by the user (for example, visually) or electronically through, for example, software.

“delaying” in the context of the invention means preventing an occurrence for a limited amount of time. The amount of time can be fixed, variable, or depend upon a further action.

“designator” means an identifiable signal associated with an addressee of an electronic communication. A designator is identifiable by, for example, a human, using the sense of hearing, or sight, or touch, or smell, or taste. A designator can also be identifiable by an electronic input device, such as a scanner. A designator can also be identifiable electronically throught eh use of software. For forms readable by human reviewers, the designator can be incorporated into the particular destination address, such as for example having the particular address appear in a designated color, or having a “pop-up” appear listing the destination address and its associated designators. Designators can be displayed in conjunction with the destination address, meaning that in embodiments utilizing visual designators and review by the message creator, the designator can be incorporated into the destination address, such as via color or font type, Designators can also, for example, be displayed within the message body of an electronic message.

“destination address” can be any identifier used to specify the recipient of an electronic message, for example, a photograph, a phone number, an email address, a domain name, an avatar, a nickname, etc.

“displaying” means means making information available to a reviewer. For example, to display information to a human reviewer the information could appear on a computer monitor or touch screen or phone display, etc.

“electronic communications” means any transfer of signs, signals, writing, images, sounds, data, or intelligence of any nature transmitted via electronic means, including both analog and digital communications. Electronic communications can include, for example, email, text messages, instant messages (IM's), “personal messages”, “tweets”, faxes, telephone calls, and the like.

“electronic communication creator” or “message creator” or “electronic communication originator” means the entity creating the communication, for example the person drafting the email.

“electronic communications system” means any system that can be used to electronically transmit an electronic message. Such systems can include both hardware and software. The software used by an electronic communications system can be email programs and systems, such as Microsoft Outlook, Gmail, Mozilla Thunderbird, and the like.

“external” in the context of the invention means a company or entity apart from the company or entity of the electronic message creator.

“form readable by the reviewer” means for human reviewers the forms must be one understandable by humans, such as a form that can be recognized by the sense of touch, taste, sight, hearing, or smell. For review performed by the system itself (such as, for example, electronically) the form can be any signal readable by the reviewing software or hardware.

“inputs” are the signals provided by a user to the system to satisfy criteria of the invention. They can include keystrokes, movements, sounds, visual exposures such as that of a retina or thumbprint, etc.

“internal” or “internal source” means originating within an organization or group, such as within a company.

“means for accepting input from a user” within the context of the invention means any input device, such as, for example, a touchscreen, a keyboard, a microphone, a scanner, etc.

“means for assigning a designator to the input data” within the context of the invention means hardware and or software designed to identify characteristics of the input data and based on those characteristics associate a designator to the input data. This can include, for example, assigning a color designator to a phone number based on the phone number being an electronic message address of a friend. Characteristics can include phone numbers, email addresses, domain names, twitter addresses, and the like.

“means for reviewing the designator” within the context of the invention means hardware or software or human senses able to identify and analyze the designator, such as, for example, comparing the designator to the designators associated with other destination addresses of the message, or comparing the designator with criteria.

“metric” means the standards, criteria, or rules used in analyzing designators. For example, if the metric includes a requirement that all addressees of a communication are assigned the same color designator before the message is sent, then the reviewer can prevent the transmission of a message whose addressees include designators of multiple colors.

“preventing” in the context of the invention means stopping an occurrence.

“producing” means displaying a designator in a form readable by the reviewer. For example, in the case of a human reviewer producing could mean displaying a color designator or a sound designator or a light designator.

“reviewing” or “review” in the context of the invention means comparing the designator or designators associated with an electronic message or messages against criteria established to enhance security. For example, reviewing can mean that all of the designators are the same color, or are of compatible colors, or sounds, etc. the The reviewing can be performed electronically, such as by a software program or macro, or by a person.

“sender domain” means the originating domain of the electronic communication sender.

“Social networking websites” are sites such as www.facebook.com, www.linkedin.com, www.twitter.com, etc.

“User interface” in the context of the invention is any means for users to input data, such as a touchpad, a keyboard, a monitor screen, etc.

“validity” or “validate” or “validating” in the context of the invention means that the destination address or address set meets the criteria established to govern the transmission of electronic messages. An invalid address set does not meet the criteria established to govern the transmission of electronic messages and its transmission can be prevented or delayed. For example, if a criteria for valid email addresses are those not ending in “gmail.com” then an email addressed to a gmail.com addressee would be invalid. If criteria for permissible email address sets are those not including designators of more than one color, then an address set that contained both blue and red email addresses would be invalid.

### DRAWINGS

FIG. 1 shows a flow-chart description of an embodiment of the invention.

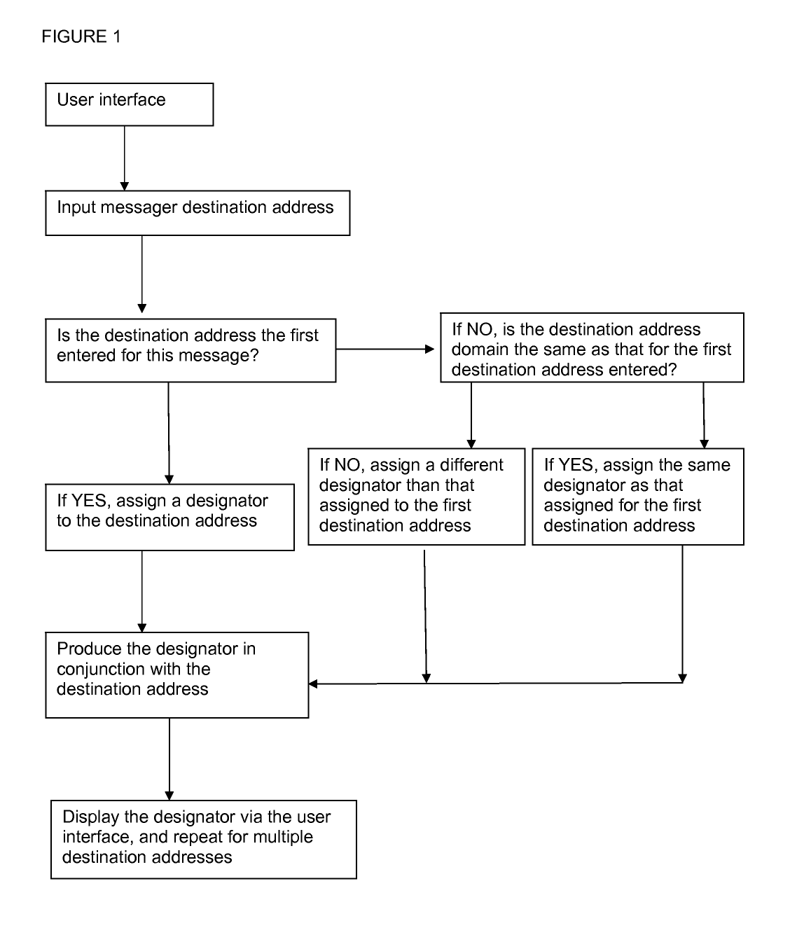

### DESCRIPTION OF EXEMPLARY EMBODIMENTS

Embodiments of the invention provide systems, methods, and devices for preventing or delaying the transmission of electronic communications, such as, for example, personal messages (“PM's”) “tweets”, text messages, voicemails, email, and the like. In certain embodiments, the invention can comprise software that can add to, modify, or replace current electronic communications software, such as email programs including, for example, Microsoft Outlook, Mozilla Thunderbird, Gmail, or the like. In certain embodiments, the invention can add to or modify social networking websites such as, for example, LinkedIn, Facebook, Twitter, and the like. Certain embodiments can prevent the transmission or attachment of “attached” files, such as, for example, documents, data sets, photographs, or the like.

In some embodiments, the invention can prevent incoming emails from designated sender domains to be delivered during certain times. For example, a user can employ an embodiment of the invention to prevent emails from “internal” sources from being delivered during designated periods of the day, such as, for example, from 2 pm to 5 pm, or the like. In some embodiments, the invention can prevent outgoing emails sent to designated domains to be delivered during certain times. For example, a user can employ an embodiment of the invention to send emails during certain times, such as, for example, at 8 pm local time to destination email addresses associated with physical locations on Easter Standard Time.

Process Interruption

In certain embodiments, the invention can comprise methods and devices, such as, for example, software programs, designed to interrupt the process of sending of an electronic message such as, for example, an email, a text message, a PM, or the like. In certain embodiments this interruption can comprise, for example, delaying the process, halting the process, or the like. For example, embodiments of the invention can require the user to input one or more signals, or confirmations to the program before the electronic message is sent. In certain embodiments, the input can comprise a keystroke, a vocal command, an optically-recognized input, a mouse-click, or the like, or a combination thereof. In some embodiments, the user input can be required to comprise multiple inputs, such as, for example, two or more keystrokes, or two or more mouse clicks, or two or more vocal commands, or two or more optically-recognized inputs, or a combination thereof, or the like. In certain embodiments the user can designate the inputs he or she wish to use to initiate the send process, such as, for example, two keystrokes, or the like. In some embodiments the multiple user inputes can be required to be imputed simultaneously, or within a designated period of time of one another.

In certain embodiments an administrator or manager can designate the inputs he or she wishes a group of users to use to initiate the send process, such as, for example, two keystrokes, or the like. In certain embodiments multiple keystrokes can be required to occur, for example, simultaneously, within a pre-set period of time, sequentially, a combination thereof, or the like. The keystrokes can be of the same key or of different keys. For example, the two keystrokes can comprise pressing both the ctrl key and the shift key within a discrete time period, such as, for example, 0.5 seconds, or the like. In certain embodiments the user can select the time period, such as, for example, less than 0.1 seconds, or 0.1 seconds, or 0.2 seconds, or 0.3 seconds, or 0.4 seconds, or 0.5 seconds, or 0.6 seconds, or 0.7 seconds, or more than 0.7 seconds, or the like. In certain embodiments. the user input can comprise clicking on a pop-up window, or dragging a screen-displayed entity from one location to another. In certain embodiments the electronic message will be not be sent until the user inputs the correct confirmation.

In certain embodiments, a supervisor or manager can designate that certain types of messages can require heightened “send” procedures. For example, a manager or other responsible party can designate that any email messages sent from within her company to a certain address must be sent via multiple user inputs, to prevent accidental transmission of messages.

Process Prevention

In certain embodiments, the invention can review the electronic message, along with its attachments and addressees, and confirms that the message, attachments, and addressees meet the criteria established by a user or administrator. In certain embodiments the invention can prevent message transmission should the criteria established by a user or administrator not be satisfied.

For example, methods of the present invention can interrupt the user-directed sending of an email message until the user verifies the destination email addresses listed in the email's address bar. For example, in an embodiment, when a user clicks the send button, the software responds by producing on the monitor a dialog box containing the destination email addresses associated with the email. In certain embodiments the user must then click the dialog box to resume the email send sequence.

In certain embodiments, destination email addresses can be assigned a designator, such as, for example, a color, a font type, a sound, a movement, a light, or the like, by the user to indicate, for example, specific companies, specific co-workers, specific management personnel, specific clients, specific personal acquaintances, and the like. The designators can vary in frequency, such as, for example, a sound that changes in pitch. In some embodiments the designator can be assigned to certain web addresses. For example, all email addresses that include “@microsoft” can be colored red. In certain embodiments, this designator can be combined with other embodiments of the invention, so that an appropriate level of security can be achieved. For example, a user can select a color to indicate coworkers within her company. Once so designated, a glance at the email address field can quickly confirm that an email intended for internal communication is safely kept within the company. In certain embodiments, different designators can be used to indicate different clients, to ensure that a communication intended for one client is not mistakenly sent to another. For example, during litigation, at certain points a law firm may need to communicate with a number of parties, including, for example, their clients, attorneys within the firm, and even attorneys representing the opposing party. The law firm can use an embodiment of the invention to insure that privileged information is kept within a select group of users. For example, if the client is named ACME, with email addresses ending in “@acme.com” then email addresses ending in “@acme.com” can be assigned the color red. The email addresses of the firm's attorneys associated with the case can be colored red as well, or designated as “internal” email addresses with an appropriate color, such as blue, or colored blue and red. The email originator can then quickly visually inspect the listed email addresses to ensure that the email is not being sent to an inappropriate address by confirming that the address field of the email message is populated solely by addresses colored either red or blue or red and blue.

In certain embodiments the designators are not based upon the validity of the email address. In certain embodiments the designators are based upon the validity of the email address as well as the user-input criteria.

In certain embodiments, the invention can, upon the user inputting the correct confirmations, analyse the email addresses according to a user designated metric to ensure that the email is not being sent to an inappropriate address. Referring to the above example, if the email message described above included an email address of opposing counsel, and the user or administrator had assigned those addresses the color green, an embodiment of the invention can be used to block transmission of any message that included both red and green email addresses. Further, in some embodiments, the user can be provided an “override” capability to circumvent the invention's block of the email message.

In certain embodiments, the number and degree of confirmations required to send a message can be assigned individually within a company, such that, for example, a more junior user is subject to review by an embodiment of the invention prior to an email being transmitted, while an administrative assistant is required to visually confirm her intended email recipients, and a vice president is subject to no or little restraint. In some embodiments, a log can be kept of the number or percentage of emails sent to particular domains or categories of domains.

In some embodiments, attachments can be designated in a similar manner as email addresses are, such as, for example, by color, font, etc., to indicate the type or origin of the attachment.

In embodiments, attachments to outgoing messages can be tagged such that when the attachment is forwarded a notification email is sent to the original sender.

In certain embodiments, the invention analyzes the designators assigned to the various email addresses associated with an outgoing message. In certain embodiments, the analysis can include comparing the designators to ensure that they are compatible, such as, for example, all of the same color, or font, or sound, or the like, to ensure that the outgoing email is limited to email addressees within the same company, or within the parties to a business transaction, or a litigation, or the like.

Certain embodiments can be used to associate certain email signatures with certain email addressees. For example, an email to a client can provide business contact information, while an email to an associate can provide business as well as personal contact information, such as, for example, a cell phone number.

In certain embodiments, a photo or other visual identifier can be associated with certain destination addresses. For example, typing in a destination email address can cause a photo or other visual identifier to “pop up” or otherwise be displayed upon the screen or viewing device. In certain embodiments, visual identifiers on the receiving end of the message (the addressee) can be used as confirmation that the email is being viewed by the correct addressee. For example, a worker can send an email or other electronic messassge to an addressee. In order to view the message, the addressee must display (to, for example, a webcam, microphone, or other input-capture device) the correct identifier, such as, for example, their face, their thumbprint, their retina, their voice, or the like.

In certain embodiments, the invention allows users to set the confirmations based upon the designator assigned to a particular email address. For example, a user can set the program to require multiple keystrokes before sending an email message to a particular email addressee, while requiring fewer user inputs to send an email message to other users. When email addresses associated with varying confirmation requirements are associated with a single email, the email address associated with the highest send trigger requirement can determine the requirement for the entire email message. For example, if an email is to be sent to several officers of another company, the number of user inputs necessary can be based on the senior addressee; i.e., additional user inputs can be required to email the president of a company as compared to the number of user inputs required to email a lower level manager.

In certain embodiments, methods of the invention can include:

1) Inputting the Destination Addresses.

The message creator inputs the destination address of the electronic message, for example either by entering the address manually or responding to a received message, for example “replying” or “replying all.”

2) Assigning a Designator are to the Destination Addresses.

The destination address is associated with at least one designator based on criteria established by the user or a third party, such as an administrator or manager. The criteria can be “positive” criteria or “negative” criteria or “characteristic” criteria. Positive criteria are criteria that can allow the transmission of an electronic message. For example, the destination addresses' presence on a list of approved destination addresses is a positive criteria. The destination address' non-appearance on a list of prohibited destination addresses is a negative criteria. Characteristic criteria can be assigned by the message creator or third parties (for example, a manager or an Information Technology department), and can include, for example, specific colors assigned to certain destination addresses or domains, or specific sounds assigned to certain destination addresses or domains, or specific vibrations assigned to certain destination addresses or domains, or combinations of colors, sounds, and vibrations assigned to certain destination addresses or domains, or combinations thereof, or the like. These designators can be assigned as “default” values so that they are assigned to particular message destinations automatically. For example, the destination address of a lawyer working for the same company as the message creator could be designated with the color blue, to indicate an “internal” (within the creator's company) email address. For multiple destination addresses, each can be analyzed by the same criteria (positive, negative, and characteristic) to establish, for example, the presence or absence of any prohibited destination address, the presence or absence of any approved destination address, and to review the appropriate characteristic criteria. To continue the lawyer example above, the designator assigned to the lawyer's destination address could be, for example, blue to indicate an internal address, and green to indicate his involvement with a particular matter or client. The destination addresses related to the particular client can also be assigned green, and a negative criteria that could be assigned to this clients' destination addresses could prevent messages from being sent to the client if they contain any designator color other than, for example, blue (indicating an internal destination address) and green (indicating a destination address associated with that client). To continue with the lawyer example, the destination addresses associated with, for example, a prospective client can be included on a list of prohibited destination addresses until the prospective client engages the company and any conflicts of interest are resolved. In an embodiment the lawyer who initiated contact with the prospective client can be allowed to use the destination addresses associated with the client.

3) Producing the Associated Designator.

The designators are produced in such a way that allows the reviewer to review the destination addresses or addresses to confirm the validity of the address or the address set. The designator can be human-readable or not, though in embodiments utilizing a human such as the message creator to review destination address or address set validity the designator should be in a human-readable form, such as, for example, color, tone, light, sound, vibration, etc. In embodiments wherein the system itself validates the set of addressees, the designator can be of any form recognizable by the system. In embodiments the criteria established with which to review the destination addresses can be applied by a human reviewer such as the message creator or a manager, or by software, or by a combination thereof. For example, in embodiments the positive and negative criteria can be reviewed by the system while the characteristic criteria can be reviewed by the message creator. In an embodiment the system or software employed therein can ensure that all the destination addresses associated with a message are approved, or that none of the destination addresses associated with a message are prohibited, while the message creator ensures visually that the destination addresses comprise a valid set.

4) Reviewing the Associated Designators.

The designators assigned to the destination addresses can be reviewed using the criteria established for the message creator, or established for the destination addresses, or a combination or combinations thereof.

For example, in embodiments a valid message destination addressee or address is one that has been vetted previously, for example to ensure its validity, or to ensure its appearance on a list of approved addresses, or its non-appearance on a list of non-approved addresses. In embodiments, the validity of a set of destination addresses can determined by criteria including the requirement that all destination addresses must be the same designator, or the same designators, or compatible designators, such as, for example, the same color, or compatible colors, or not incompatible colors. In embodiments, the validity of a set of destination addresses can determined by criteria including the requirement that all destination addresses must produce the same drum beat, or compatible drum beats, or not incompatible beats.

5) If the Review Criteria are not Satisfied, Transmission of the Message can be Prevented.

For example, if the destination address set is not valid, transmission of the message is prevented. For example, if a criteria for a address set is that they are all of a single color, then an address set with designators of more thatn a single color are invalid. In embodiments a message can provide the user with information relating to the reason for stopping transmission of the message.

6) If the Review Criteria are Satisfied, Transmission of the Message can be Initiated.

For example, when the message creator clicks “send” the email addresses can be reviewed to ensure they are approved email addresses and that the set of email addresses is a valid set; i.e., the email addresses must satisfy the criteria established for this message creator or for these destination addresses, or for both the message creator and the destination addresses, such as all being assigned a particular color, or particular sound, or compatible colors and sounds, or the like. Once the review is performed and the validity of the message destinations and destination set confirmed, the email message is sent.

By way of example,a software program of the invention can be set to do the following when the email program's “send” button is clicked:
1) Display a pop-up window listing all of the email's addressees located with the “TO” and “CC” and “BCC” fields;
2) display the designator (color, font, sound, etc.) assigned to each addressee, based upon the user's assigned preferences. An email address that is not recognized as being on a preapproved list by the program can be assigned a particular designator to alert the user that the particular email address has not been used previously;
3) display an “OK TO SEND?” button for the message originator to click;

depending on the user's selected parameters this can be the only input required to send the message, or the program can;
4) require additional user inputs (e.g., additional keystrokes or mouse clicks) prior to sending the email.

### EXAMPLES

### Example 1

A 22 year old marketing assistant is unable to quickly and accurately send out email communications. Her company installs a software version of an embodiment of the invention to help her organize her email system (Microsoft Outlook). The assistant uses the invention to assign the color red to the email addresses of the company's biggest client (Client A), yellow for that client's biggest competitor (Client B), green for smaller clients, and blue for internal email addresses. Now, the assistant knows that any internal communications should only include blue email addresses in the message's address bar, while any communications to Client A should only contain red and possibly blue addresses. The assistant employs the invention to, upon clicking the “send” button, generate a pop-up window containing all the email message's addressees. The addressees appear in the color assigned by the assistant (red for Client A, etc.). Once the assistant sees the pop up window, she visually confirms that the addresses are the proper color, then clicks an “OK?” button on the pop-up to confirm her intent to send the message. The message is sent to the correct recipients.

### Example 2

A 28 year old lawyer mistakenly sends out privileged material to the wrong client. To ensure that this does not happen again, his law firm installs a software embodiment of the invention. The lawyer assigns different colors to his various clients, and when addressing future emails he knows that there can never be more than a single client “color” in the email program's address set. To further protect the firm's email security, the lawyer sets the program to display a pop-up window whenever the email program's “send” button is clicked. This pop-up window displays the addressees of the message, providing further opportunity to ensure that the message's addressees are of a single color. As an additional safeguard, the lawyer sets the program parameters to require both an “OK TO SEND?” click on the pop-up window as well as depressing the “ctrl” key before the message is sent.

### Example 3

A firm is negotiating a contract with various vendors. The firm uses an embodiment of the invention to assign different color codes to the various vendors and prevent the accidental transmission of email to the incorrect vendor. Vendor A is assigned the color orange and Vendor B is assigned the color brown. To assure absolute secrecy, the firm does not enable the manual override feature of the invention, thus the invention will block any outgoing emails that include orange and brown destination addresses. If an employee addresses an email such that it contains both orange and brown destination addresses, the email will not be sent. Transmission of the message will be prevented until the destination addresses are of a single color.

### Example 4

A temporary employee is hired to attend to the duties of an employee who is out on medical leave. To ensure email security, the employer installs a software embodiment of the invention and sets the security program to only allow the temporary employee to send emails to blue (internal) email addresses. Once the employee has established himself as trustworthy, he can be allowed to send external emails to destination email addresses that are approved by the company.

### Example 5

An employee with impaired vision designates different sounds as designators for the email addresses of different clients. Then, any message addressed to more than one client will produce more than a single sound. In this example, one the email addresses of one external company to whom the employee sends email is assigned an audible birdsong designator. Another external company is assigned an audible “choo choo” designator. The employee knows that if she hears birdsong and a train sound when she is addressing outgoing email then she must not send the message.

### Example 6

A parent uses an embodiment of the invention to limit transmission of text messages from a child's cellular phone. Before a text can be sent, the parent must have added the destination address to a list of permissible destination addresses. When a non-permissable destination address is inputted by the message creator, an electronic permission request is sent to the parent, who must approve the destination address before it can be used. Once used, the destination address is added to a list of approved addresses, so that the child can both send messages to and receive messages from that message address.

### Example 7

An executive assistant is unable to quickly and accurately send out email communications. Her company installs a software version of an embodiment of the invention to help her organize her email system (Microsoft Outlook). The assistant uses the invention to assign an audible drum beat sound (120 beats/minute) to the email addresses of the company's biggest client (Client A), an audible banjo sound for that client's biggest competitor (Client B), an audible trumpet sound for smaller clients, and an audible flowing water sound for internal email addresses. Now, the assistant knows that any internal communications should only include produce flowing water sounds, while any communications to Client A should only produce a 120 bpm drum sound. The assistant has set the invention to, upon clicking the “send” button, generate a pop-up window containing all the email message's addressees. Once the assistant sees the pop up window, she aurally confirms that the addresses produce the proper sound, then clicks an “OK?” button on the pop-up to confirm her intent to send the message.

### Example 8

A junior ranking military person works on classified material on a daily basis. To prevent the person from communicating classified material to unauthorized persons, any destination email address inputted by the person is reviewed electronically, and if the destination email address is not an authorized address, transmission of the email is prevented. The attempted use of the destination address is recorded for further review.

### Example 9

An elderly gentleman finds it difficult to input the email addresses of his friends and family. Utilizing a software embodiment of the invention, a friend of the gentleman's helps him set up his email addresses so that they are identified with visual designators. The email and text addresses of the man's children are designated blue, the email and text addresses of the grandkids are red, and those of his friends are green.

### Example 10

An executive secretary composes an email to her company's biggest client (client A). Upon entering the first destination address, the email message body turns light green, as light green is the designator assigned to the client. As the secretary adds to the list of addressees, the email addressees also appear in light green, as they are all employed by the client. The “CC” field includes internal destination addresses, including the executive she works for, and these destination addresses appear in light green also, as the embodiment of the invention used by the company is set to display internal destination addresses in the same color as the client destination addresses. When the client accidentally enters the destination address of an employee for a different company (Client B), that destination address appears in red, because red is the color assigned to client B. A red color also appears in the message body, to indicate the presence of email destination addresses of more than one client. Upon a visual review, the secretary realizes her error and removes the client B email address.

### Example 11

An entrepreneur is drafting an email to several potential investors. As he enters the destination email addresses, the first appears in red, as does the next, because the embodiment of the invention used by the entrepreneur is set to assign the domain name of the first destination addressee the color red, then assign the first destination addresses whose domain names do not match that of the first addressee the color blue, then green for the destination addresses whose domain names do not match that of the first addressee or the second addressee, etc. By visually reviewing the destination addresses, the entrepreneur can quickly confirm the number of domain names that he has addressed his message to.

### Example 12

A user of a social network wishes to invite selected fellow users to an art exhibit. The user has previously designated the electronic message addresses with multiple color designators, such as red for art enthusiasts, blue for her friends interested in fine dining, and green for the friends interested in sports. Each electronic message address can be associated with multiple designators, such as blue and red for friends interested in art and dining. So, to invite friends most likely to enjoy dinner and an art show, the social network user clicks on the blue and red tab in her email address book.

### Example 13

A user of a social network wishes to share the news of her upcoming wedding. After she adds the message destination addresses of those she intends to notify, she visually scans the addresses to ensure that they all appear in green, confirming that these addresses belong to her personal friends and not work colleagues. She then sends the same message to her family, again checking the addresses visually prior to sending the message. This time she ensures that she hears a drum beat before sending the message, as all the electronic message addresses belonging to her family (email addresses, phone numbers, twitter addresses, etc.) are designated with a drum beat.

What is claimed is:

1) A method for validating the destination address of an email communication comprising;
a) associating at least one visually recognizable designator to the destination address, wherein the designator is associated based upon the domain name of the destination address;
b) producing for visual review the designator in conjunction with the destination address;
c) visually reviewing the designator assigned to the destination address; and
d) preventing transmission of the email if the email's destination address is not valid.

2) The method of claim 1 wherein the review is performed by the email originator.

3) The method of claim 1 wherein the review is performed electronically.

4) The method of claim 2 wherein the visually recognizable designator is color.

5) The method of claim 2 wherein the visually recognizable designator is font type.
